(19) United States
(12) Patent Application Publication
(10) Pub. No.: US 2026/0343254 A1
(43) Pub. Date: Oct. 29, 2026

(54) RETRIEVAL AUGMENTED GENERATION (RAG) AND IMAGE SEARCH/UNDERSTANDING FOR NETWORK AND EQUIPMENT ASSESSMENT AND IMPROVEMENT

(71) Applicant: AT&T Intellectual Property I, L.P., Atlanta, GA (US)

(72) Inventors: HONGXU DONG, HOUSTON, TX (US); Bo Gu, Allen, TX (US); CUNPING FAN, PLANO, TX (US); YI CAI, FRISCO, TX (US); JINGWEI ZHANG, IRVING, TX (US)

(73) Assignee: AT&T Intellectual Property I, L.P., Atlanta, GA (US)

(21) Appl. No.: 19/187,067

(22) Filed: Apr. 23, 2025

(51) Int. Cl. H04W 24/02; G06F 16/532; G06F 16/56

(52) U.S. Cl. CPC H04W 24/02; G06F 16/532; G06F 16/56

(57) ABSTRACT

Aspects of the subject disclosure may include, for example, receiving an input image relating to one or more network elements of a telecommunications network, deriving an embedding based on the input image, resulting in an input image embedding, conducting a search for the input image embedding in a vector database that stores embeddings associated with images relating to telecommunications network elements, determining whether a particular embedding in the vector database corresponds to the input image embedding, and based on a determination that there is a lack of a particular embedding in the vector database that corresponds to the input image embedding, causing a corrective action to be taken with respect to the one or more network elements of the telecommunications network. Other embodiments are disclosed.

### FIELD OF THE DISCLOSURE

The subject disclosure relates to Retrieval Augmented Generation (RAG) and image search/understanding for network and equipment assessment and improvement.

### BACKGROUND

In the rapidly evolving digital landscape, the ability to efficiently search and retrieve images stored in an unstructured format has become increasingly important. Traditional methods of image search rely heavily on manually created metadata, such as descriptions, names, or tags, to facilitate the retrieval process. This approach is labor-intensive and prone to human error, often resulting in incomplete or inaccurate metadata that hampers the effectiveness of image searches. As organizations accumulate vast repositories of visual data, the challenge of managing, accessing, and leveraging this information becomes more pronounced, necessitating innovative solutions that can automate and enhance the search process.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within, or operatively overlaid upon, the communications network of FIG. 1 in accordance with various aspects described herein.

FIG. 2B illustrates an example of image compliance assessment and corrective action triggering by the system of FIG. 2A, accordance with various aspects described herein.

FIG. 2C is a block diagram of an example system that facilitates image generation, in accordance with various aspects described herein.

FIG. 2D depicts an illustrative embodiment of a method in accordance with various aspects described herein.

FIG. 2E is a diagram of an example artificial intelligence (AI) architecture, which may be used to facilitate training or pre-training of one or more AI models, including, for instance, large language models (LLMs), in accordance with various aspects described herein.

FIG. 2F is a diagram of an example transformer model, a portion or an entirety of which may serve as a functional building block of one or more LLMs, in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

Existing image search solutions often require significant computational resources, such as powerful graphics processing units (GPUs), to process multi-modal data, which can be cost-prohibitive and inefficient for many applications. Moreover, these methods typically lack the capability to integrate visual and textual data seamlessly, which limits the contextual relevance and accuracy of search results. The need for a streamlined approach that can automatically generate metadata and perform high-accuracy image searches without extensive manual input or resource-intensive processing is evident. Such advancements would not only improve operational efficiency but also enhance user experience by providing quick and relevant access to visual information, thereby driving engagement and satisfaction across various sectors.

The subject disclosure describes, among other things, illustrative embodiments of AI-enabled image searching in which image metadata is derived and images are indexed in a way that facilitates search efficiency and accuracy. An AI-based system may utilize AI model(s) for image understanding and generation of textual descriptions of images. The AI-based system may leverage RAG techniques to process inputs that are generated from image descriptions, and may employ embedding and vector search methods to identify (e.g., the best) matching images from the index and return corresponding results. This automated capability facilitates the provision of visual content that can effectively explain various terms or services, such as those relating to network architectures, systems, elements, etc. In one or more embodiments, the AI-based system may employ a multi-modal approach in which both text and image searching are performed and results are derived from both text and image search results.

In certain embodiments, the AI-based system may include an image generation component that leverages diffusion-based image synthesis or other generative techniques to create new data samples. The image generation component may be capable of generating (e.g., high quality) images that align with textual descriptions, by leveraging a process that refines random noise into coherent images through a series of transformations.

In exemplary embodiments, the AI-based system may be capable of assessing the compliance of network components, such as antennas, base station equipment, core network equipment, or the like by comparing real-time (or near real-time) images of network equipment sites (e.g., captured by sensors, such as those mounted on uncrewed aerial vehicles (UAVs)) with a database of compliant images. The AI-based system may obtain a given image, and may perform a search in the database for a matching image that is known to be in compliance with particular requirements. If a matching image is found, the AI-based system may confirm compliance; otherwise, the AI-based system may trigger one or more corrective actions to address the non-compliance.

By automating metadata generation, the AI-based system reduces the need for manual input, which streamlines the process of indexing and retrieving images and enhances search accuracy and efficiency. By integrating visual and textual data, the AI-based system provides more comprehensive and relevant search results, which can more effectively explain various technical terms. This is particularly beneficial for field teams and customer care teams, as it facilitates the provision of visual content that aligns with their specific needs. For example, users looking for network coverage maps or setup procedures for new devices can find what they need instantly.

By utilizing LLM-empowered image understanding, the AI-based system can automatically generate and summarize image descriptions and tags from the RAG database. The implementation of image search functionality within a RAG framework, along with the ability to perform similarity searches based on generated embeddings, ensures that users can quickly and accurately retrieve relevant images. By leveraging a vast repository of images, such as architectural diagrams, manuals, procedures, etc., organizations can streamline operations. Engineers and technicians can effortlessly locate relevant visuals, improving efficiency in network maintenance and service deployment through direct search capabilities. The use of embedding and vector search enables efficient handling of large-scale image databases, which is crucial for managing visual data associated with extensive network infrastructure and customer support materials.

Compliance checking offers significant benefits by ensuring that network components meet required standards, thereby maintaining the reliability and safety of the network infrastructure. By comparing (e.g., real-time) images of components with a database of compliant images, the AI-based system can quickly identify any deviations from compliance, thus allowing for timely corrective actions. This process reduces the risk of operational issues caused by discrepancies and helps maintain desired (or optimal) network performance.

It is to be understood and appreciated that the AI-based system’s operation may not require the use of powerful GPUs, which are necessary for existing multi-modal LLM-based solutions. This makes the AI-based system more accessible and cost-effective, which allows for broader implementation across different sectors.

One or more aspects of the subject disclosure include a system, comprising at least one processor, and a memory that stores executable instructions that, when executed by the at least one processor, facilitate performance of operations. The operations can include receiving an input image relating to one or more network elements of a telecommunications network. Further, the operations can include deriving an embedding based on the input image, resulting in an input image embedding. Further, the operations can include conducting a search for the input image embedding in a vector database that stores embeddings associated with images relating to telecommunications network elements. Further, the operations can include determining whether a particular embedding in the vector database corresponds to the input image embedding. Further, the operations can include based on a determination that there is a lack of a particular embedding in the vector database that corresponds to the input image embedding, causing a corrective action to be taken with respect to the one or more network elements of the telecommunications network.

One or more aspects of the subject disclosure include a non-transitory machine-readable medium, comprising executable instructions that, when executed by a processing system including a processor, facilitate performance of operations. The operations can include receiving an input image relating to one or more network elements of a radio access network (RAN). Further, the operations can include deriving an embedding based on the input image, resulting in an input image embedding. Further, the operations can include conducting a search for the input image embedding in a vector database that stores embeddings associated with images relating to RAN elements. Further, the operations can include determining whether a particular embedding in the vector database corresponds to the input image embedding. Further, the operations can include based on a determination that there is a lack of a particular embedding in the vector database that corresponds to the input image embedding, causing a corrective action to be taken with respect to the one or more network elements of the RAN.

One or more aspects of the subject disclosure include a method. The method can comprise receiving, by a processing system including a processor, an input image relating to one or more elements of a core network. Further, the method can include deriving, by the processing system, an embedding based on the input image, resulting in an input image embedding. Further, the method can include conducting, by the processing system, a search for the input image embedding in a vector database that stores embeddings associated with images relating to core network elements. Further, the method can include determining, by the processing system, whether a particular embedding in the vector database corresponds to the input image embedding. Further, the method can include based on a determination that there is a lack of a particular embedding in the vector database that corresponds to the input image embedding, causing, by the processing system, a corrective action to be taken with respect to the one or more elements of the core network.

Other embodiments are described in the subject disclosure.

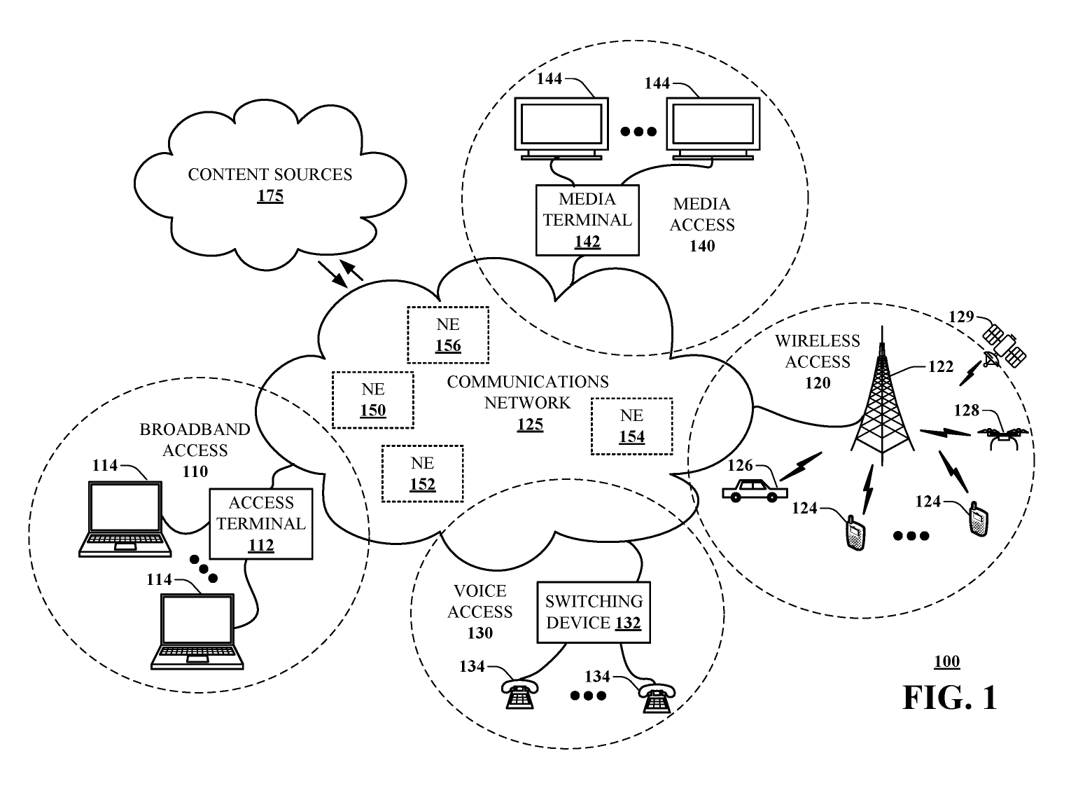

Referring now to FIG. 1, a block diagram is shown illustrating an example, non-limiting embodiment of a system 100 in accordance with various aspects described herein. For example, system 100 can facilitate, in whole or in part, RAG and image search/understanding for network and equipment assessment and improvement. In particular, a communications network 125 is presented for providing broadband access 110 to a plurality of data terminals 114 via access terminal 112, wireless access 120 to a plurality of mobile devices 124, vehicle 126, and uncrewed aerial vehicle (UAV) 128 via base station or access point 122 (and/or via satellite(s) 129), voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices. In various embodiments, the satellite(s) 129 can be configured for bi-directional communication with one or more access points, with one or more base stations, and/or with one or more mobile devices (e.g., direct-to-cell). In various embodiments, the satellite(s) 129 can include one or more Low Earth Orbit (LEO) satellites, one or more medium earth orbit (MEO) satellites, or one or more Geostationary Orbit (GEO) satellites.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

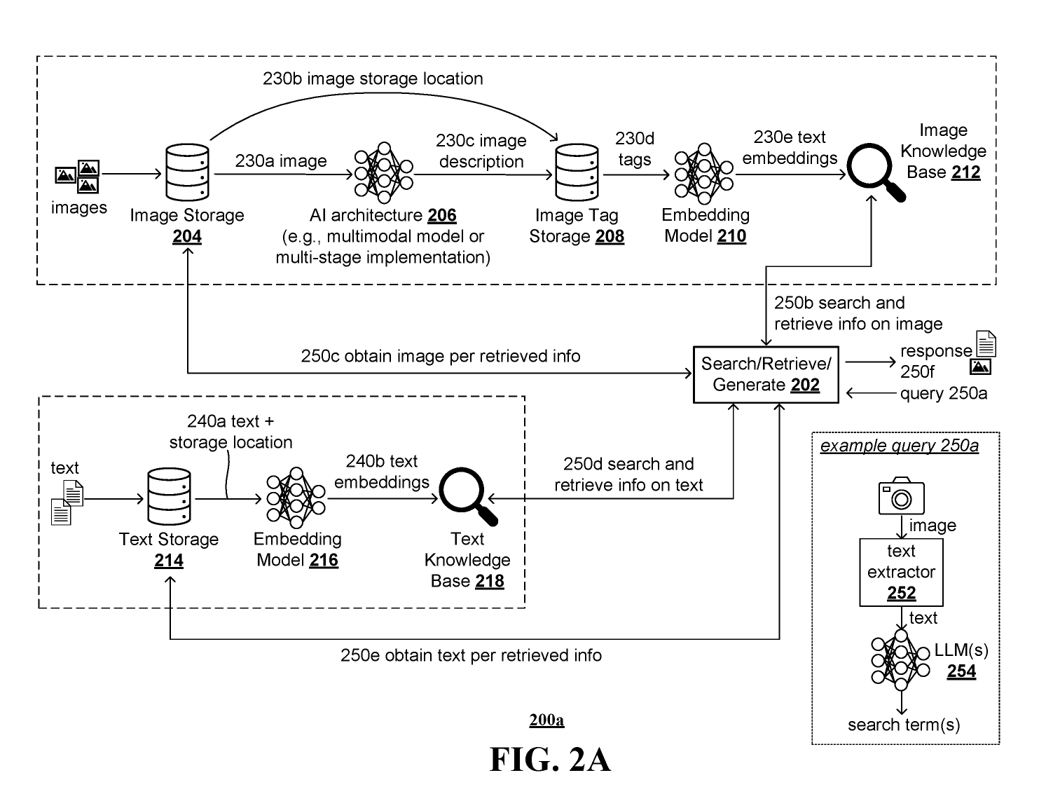

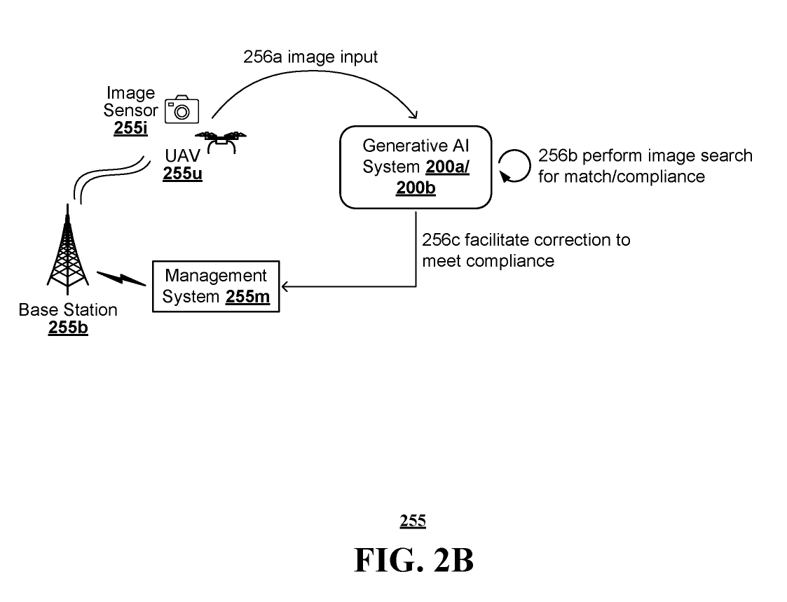

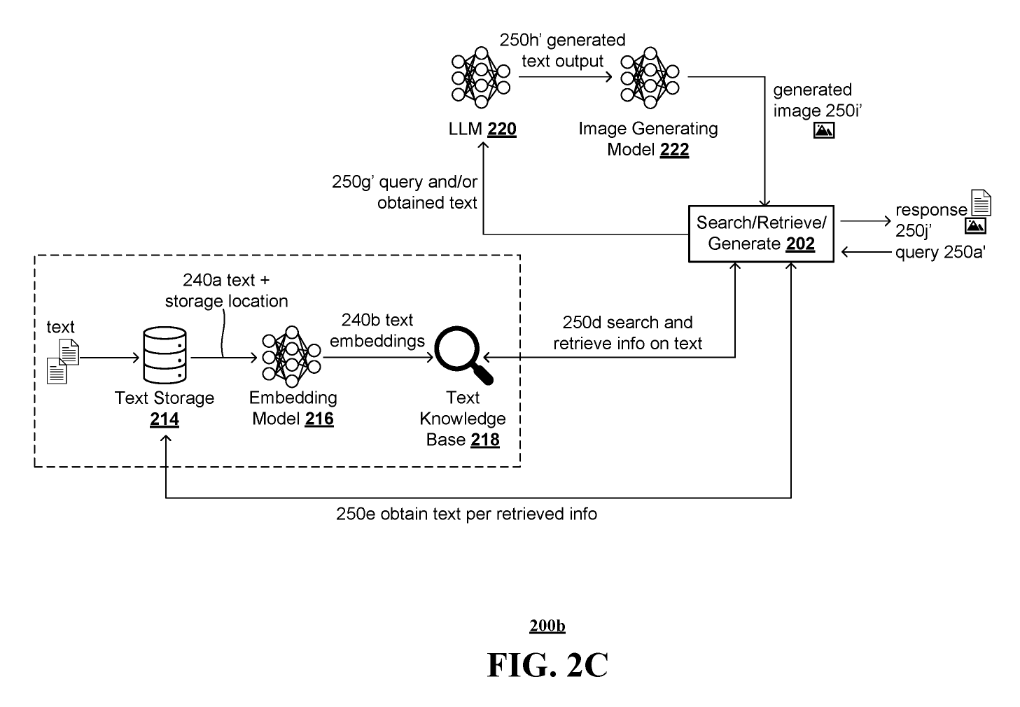

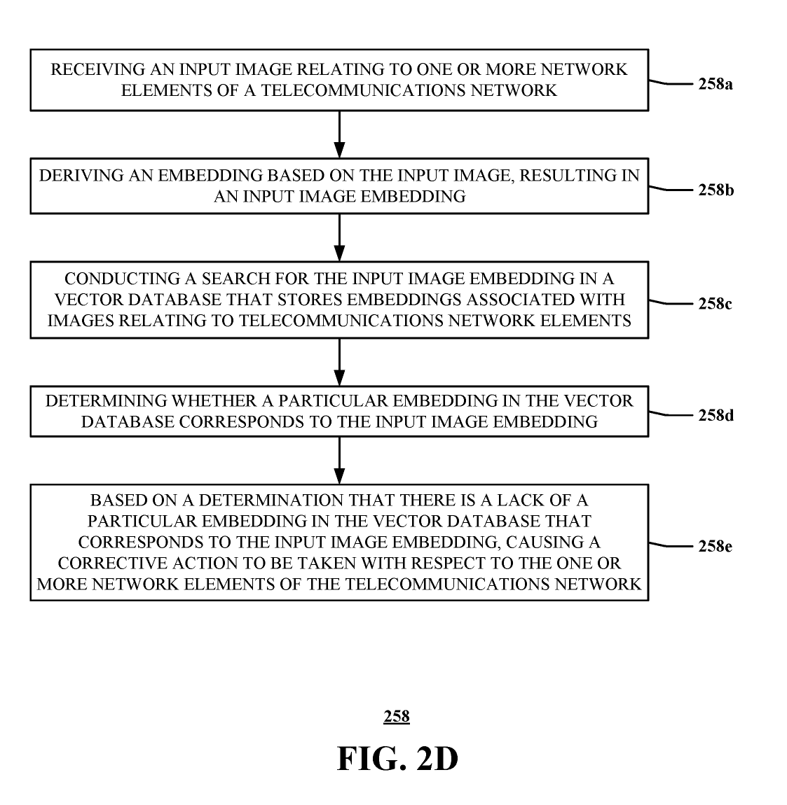

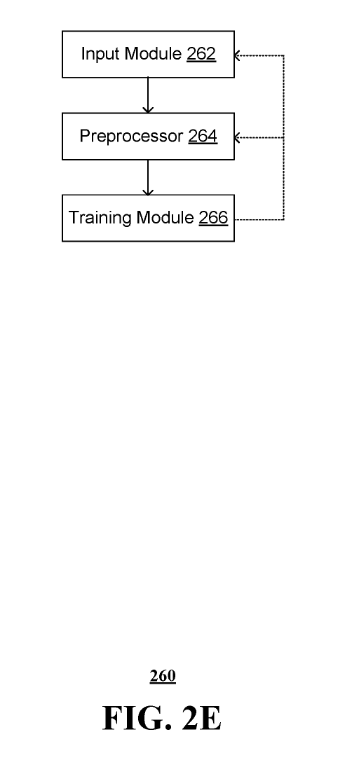

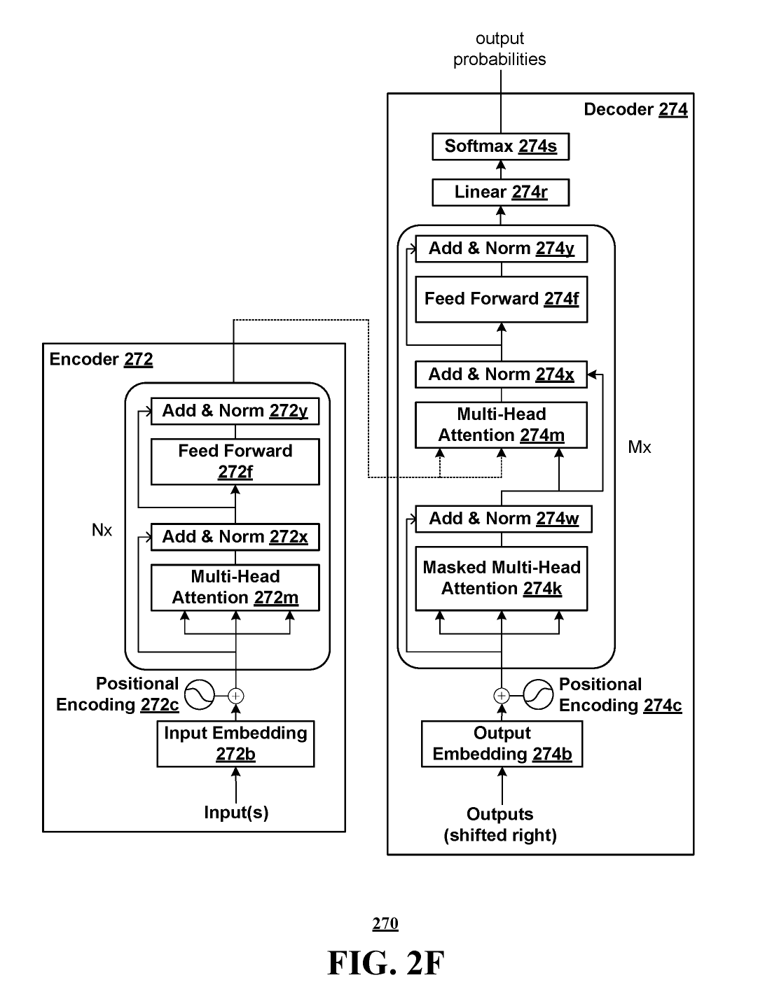

FIG. 2A is a block diagram of an example system 200a that facilitates multi-modal RAG and image retrieval, in accordance with various aspects described herein. The system 200a may function within, or may be operatively overlaid upon, the communications network of FIG. 1. In various embodiments, the system 200a may be at least partially implemented in a cloud-based environment.

The search/retrieve/generate function 202 may be configured to manage image/text retrieval and generation processes. The function 202 may interface with an image knowledge base 212 and the text knowledge base 218 to facilitate the search and retrieval (250b, 250d) of relevant images/text data based on (e.g., user) queries. One or more of the image knowledge base 212 and the text knowledge base 218 may be a vector database or the like. The function 202 may process incoming queries, such as query 250a, and determine whether the query pertains to particular image(s) or text data. The function 202 may coordinate the output of a response 250f that includes retrieved image(s) and/or text data.

The image storage 204 may be a repository for images. In the context of a telecommunications network, for instance, the images may relate to architectural diagrams or network elements, such as antennas, towers, routers, switches, wiring, electrical components, electronic components, and so on of a radio access network (RAN) and/or a core network. In one or more embodiments, the images may be manually/automatically loaded into the image storage 204 (e.g., images may be scraped from a web site or extracted from documents). The image storage 204 may provide a structured location for storing visual data that can be accessed by an AI architecture 206. The image storage 204 may support the generation of text-based descriptions 230c of images 230a, which may be stored in an image tag storage 208. The image storage 204 may coordinate with the AI architecture 206 and/or the image tag storage 208 to facilitate the generating of descriptions 230c and overall indexing of images 230a with these descriptions. For instance, the image storage 204 may communicate (230b) the location of an image whose description is to be derived, to the image tag storage 208 such that the image tag storage 208 can index the location of the image with the derived description.

The AI architecture 206 may employ multimodal models or multi-stage models to analyze and classify the images that are stored in the image storage 204. The AI architecture 206 may be responsible for generating image descriptions 230c, which may serve as metadata that aids in the searchability of the images. The AI architecture 206 may utilize advanced machine learning (ML) model(s) to interpret and extract features from visual data and derive relevant textual descriptions thereof.

In a multi-stage image implementation, the first stage may utilize a computer vision system, such as a convolutional neural network (CNN), to extract features (e.g., colors, edges, shapes, etc.) and convert them into dense vector representations. This transforms raw pixel data into embedding vectors, such as multi-dimensional arrays of floating point numbers that represent the semantic content of the image. These embeddings may capture abstract features like objects, scenes, and/or visual attributes in a mathematically comparable format. The second stage may compare the embeddings to (e.g., a database of) other embeddings that were previously generated from training images. These prior embeddings may exist in the same mathematical vector space, and may have associated text labels or captions from the training. A comparison system may identify the closest vectors in this high-dimensional space using similarity metrics, such as cosine similarity, dot product, and/or Euclidean distance. This essentially identifies the known image(s) that the current image of interest most closely resembles. The text associated with those similar embeddings may then be used to generate appropriate tags or descriptions. The multi-stage approach creates a bridge between visual and textual information through a shared embedding space. When an image is processed, its embedding serves as a “translation” of visual information into a mathematical representation that can be directly compared with other embeddings.

In an alternate implementation, the AI architecture 206 may utilize contrastive learning approaches where image-text pairs are jointly embedded during training. This creates a unified semantic space where visual and textual concepts that describe the same things are positioned close together. This allows the system to generate relevant text for new images by finding where the image embedding falls within this unified semantic space, and retrieving or generating appropriate textual descriptions based on the nearby text embeddings.

In any case, the AI architecture 206 may derive descriptions 230c for fed images 230a, and may provide the descriptions to the image tag storage 208 for storage/indexing.

The embedding model 210 may receive (or ingest) image tags 230d from the image tag storage 208. The image tags 230d may include the descriptions 230c and the corresponding image storage location information 230b for the images associated with those descriptions. The embedding model 210 may convert the descriptions into text embeddings 230e, and may provide the text embeddings and their corresponding storage location information to the image knowledge base 212 for storage. In one or more embodiments, the embedding model 210 may provide the storage location information as metadata alongside the text embeddings 230e, which the image knowledge base 212 may store as key-value pairs associated with the respective text embeddings. This effectively creates a semantic index on top of the image storage 204 that allows for image retrieval based on image semantic content.

The text storage 214 may be a repository for text data. In the context of a telecommunications network, for instance, the text data may relate to network systems/elements, such as descriptions, specifications, issue logs, etc. pertaining to antennas, towers, routers, switches, wiring, electrical components, electronic components, and so on of a radio access network (RAN) and/or a core network. The text storage 214 may provide (240a) text data and their corresponding storage location information to an embedding model 216, some or all of which the embedding model 216 may use to generate text embeddings 240b. In some embodiments, the embedding model 216 may be similar to the embedding model 210. The text knowledge base 218 may store the text embeddings 240b, and may maintain a searchable index of the text embeddings 240b to facilitate searches by the function 202.

In a case where the function 202 receives a text-based query 250a (e.g., one or more search term(s) obtained based on text extraction from a captured image and LLM-processing of the extracted text), the function 202 may convert the query into an embedding vector—e.g., using the embedding model 210 or the like—and perform a similarity search to find the closest matching embeddings in the image knowledge base 212. Once the most similar embedding(s) are identified, the function 202 can retrieve the associated image from the image storage 204 using the metadata associated with the identified embedding(s), and provide the retrieved image in the response 250f. In certain implementations, the function 202 may additionally, or alternatively, perform a similarity search to find the closest matching embeddings in the text knowledge base 218. Once the most similar embedding(s) are identified, the function 202 can retrieve the associated text data from the text storage 214 using the metadata associated with the identified embedding(s), and provide the retrieved text data in the response 250f.

Various of the AI model(s) described herein may be trained via an AI architecture (e.g., an AI architecture 260 illustrated in FIG. 2E and described in more detail below). In certain embodiments, the AI model(s) may include one or more LLMs, one or more transformer-based models, one or more auto-regressive models, one or more of another type of generative AI model, or a combination of some or all of these models. As an example, the AI model(s) may include one or more LLMs that are based on the transformer model 270 illustrated in FIG. 2F and described in more detail below.

It will be understood and appreciated that the system 200a may enable various image search use cases.

As an example, a business unit or user may specify, in a query 250a, the requirements of and the components that are needed for a telecommunications network-related project, which may involve the architecting of hardware/software platforms. The system 200a may leverage its capabilities to analyze existing diagrams and respond to the query, by automatically searching the image knowledge base 212 for architectural diagrams that align with the specified needs. The system 200a may perform a text-based search using tags that are associated with existing architectural diagrams to identify the most suitable diagram(s). The identified diagram(s) may then be retrieved and output as part of a response 250f to the query 250a, thereby providing a relevant visual aid in support of the project.

As another example, the system 200a may assist technicians who are addressing network outages but lack complete knowledge to resolve specific issues. Assume that a technician encounters an unfamiliar technical term or needs a better interpretation of an issue. In this case, the technician may input the term in a query 250a to the system 200a. The system 200a may then search the image knowledge base 212 for image(s) that visually represent the facility or structure related to the issue—e.g., fiber optics, copper wiring, or other network components. By providing relevant image(s), the system 200a may aid the technician in gaining a clearer understanding of the problem or the network’s structure.

As a further example, the system 200a may be employed to assess the compliance of network components, such as antennas, base station equipment, etc., by comparing (e.g., real-time or near real-time) images of network equipment sites with a database of compliant images. FIG. 2B illustrates an example of image compliance assessment and corrective action triggering by the system 200a, accordance with various aspects described herein. Here, images of network components may be captured by one or more image sensors 255i, such as camera(s), including those that may be mounted on UAV(s) 255u or the like. The images may be captured as part of periodic or condition-based inspection of network components. The system 200a may receive a captured image 256a of a particular component, such as an antenna, and may perform a search in one or more databases for a matching image of an antenna that is known to be in compliance. Compliance may be determined based on various criteria, including factors, such as antenna orientation, structural integrity (e.g., no chips or breaks), proper wiring, or securing mechanism (brackets, bolts, screws, etc.) condition, count, orientations/positions, etc. If the system 200a identifies a matching image of a compliant component, the system 200a may determine that the component in the image 256a is in compliance, and may output an indication of such compliance.

The system 200a may utilize advanced image analysis techniques to facilitate assessments of the compliance of network components (256c). When a captured image 256a, such as one taken by a UAV-mounted camera, is received, the system 200a may convert the image into embeddings. These embeddings may be dense vector representations that capture the semantic content of the image. The function 202 may then utilize the AI architecture 206, or what has been stored in relation to the AI architecture 206, to find similarities between the generated embeddings and those stored in the database of compliant images (256b). In various embodiments, the threshold that is used in the compliance check can be higher than that used in image retrieval described above with respect to FIG. 2A. For instance, rather than a minimum of, say, an 85% similarity score, a 95% or a 99% similarity score may be instead used as the threshold. A higher threshold ensures that only images with a very close match to the compliant standards are considered compliant, which reduces the risk of overlooking subtle defects or deviations. This stringent criterion helps to maintain the reliability and safety of network components, as even minor discrepancies can lead to significant operational issues. Once similar embeddings are found, the system 200a may retrieve and output the corresponding image from the storage location using associated storage location information (that may have already previously been communicated by the image storage 204 to the AI architecture 206).

In a case where the system 200a does not find a match, the system 200a may output an indication that the imaged component is not in compliance. In exemplary embodiments, the system 200a may additionally, or alternatively, cause one or more corrective actions to be perform in relation to the non-compliant component. This may include generating commands or data regarding particular actions to be taken, and providing the commands/data to a management system 255m that is associated with (or that is configured to control) the network equipment—e.g., in this example, the base station 255b—or their associated systems.

One possible corrective action is generating an alert to notify a network administrator or technician of the issue. This alert may include details about the component or the non-compliance, such as the site at which the component in the captured image 256a is located.

Another corrective action may involve placing a replacement order for a damaged component. To determine if a component is damaged, the system 200a may first search for any matching images in the database using a similarity metric with a higher threshold (e.g., 95% or 99%). If no matching image is found, the system may identify the closest matching image using a similarity metric with a lower threshold (e.g., 90% of 88%). The search and reduction of the threshold may continue until a minimum threshold is reached (e.g., 85% or 83%). This approach allows the system 200a to detect subtle differences between the captured image and the closest matching image. Assuming that a “matching” image is found in this iterative process, the system 200a may perform a comparison of the captured image 256a with the found image, highlighting portions of the captured image that do not match well with the reference image. For example, if the antenna in the captured image has portions that do not match portions of the found image (e.g., pixel colors differ by more than a threshold amount, edge locations differ by more than a threshold amount, etc., which may be due to chips or bends at a particular portion of the component, missing parts at a particular portion of the component, etc.), these differences/discrepancies may be circled or marked. The system 200a may reference a database (not shown) that contains historical data on similar issues, where certain marked portions indicate specific types of damage, such as corrosion or structural failure. Based on this analysis, the system 200a may automatically look up the type of antenna and determine the necessary replacement part(s). The system 200a may trigger a replacement order for the part(s) or notify a technician to perform repairs using the identified part(s). This automated process ensures timely and accurate responses to component damage, which reduces or minimizes downtime and maintains network reliability. For instance, if the system 200a detects that the securing brackets are missing or improperly positioned, the system 200a may cause new brackets to be ordered and schedule a technician visit to replace the new brackets.

In addition, or as an alternative to, physical repairs, the system 200a may suggest adjustments to environmental settings if non-compliance is due to external factors, such as excessive heat that has caused components to melt or warp. To determine if cooling adjustments are needed, for instance, the system 200a may first search for any matching images in the database using a similarity metric with a higher threshold (e.g., 95% or 99%). If no matching image is found, the system may identify the closest matching image using a similarity metric with a lower threshold (e.g., 90% of 88%). The search and reduction of the threshold may continue until a minimum threshold is reached (e.g., 85% or 83%). This approach allows the system 200a to detect subtle differences between the captured image and the closest matching image. These discrepancies may be circled or marked, and the system 200a may reference a database containing historical data on similar issues. Certain marked portions may indicate specific types of environmental damage, such as heat-induced structural failure (e.g., tip of antenna is bent, edge of a processor enclosure is warped, etc.). Based on this analysis, the system 200a may automatically look up the type of component and determine the necessary environmental settings that are appropriate for that type of component. The system 200a may trigger an order for the installation of additional cooling equipment, notify a technician to adjust existing cooling systems, or cause a management system, such as the management system 255m of FIG. 2B, to effect the adjustment. This automated process ensures timely and accurate responses to environmental damage, which reduces or minimizes downtime and maintains network reliability.

As a further example, a component, such as an antenna may be disoriented due to a software glitch. For instance, based on an iterative search process similar to that described above, the system 200a may determine that the component is oriented at a certain angle (e.g., 60 degrees relative to the ground) rather than at a more appropriate angle (e.g., 45 degrees relative to the ground) such as that depicted in a found image of a compliant component. Additionally, the system 200a may, based on a review of installation/operational specifications, determine that the disorientation is due to a software error. In this example, the system 200a may initiate a software update to rectify the problem by identifying the specific software version or configuration that has resulted in the issue, and causing a software patch or update to be downloaded and installed to a control system (e.g., the management system 255m) associated with the component.

By integrating one or more of the above-described corrective actions, the system 200a not only identifies non-compliance but also facilitates a comprehensive response to ensure that network components are restored to desired functionality.

In certain embodiments, the function 202 may be capable of leveraging one or more image generating models to generate new images in response to queries. FIG. 2C is a block diagram of an example system 200b that facilitates image generation, in accordance with various aspects described herein. The system 200b may function within, or may be operatively overlaid upon, the communications network of FIG. 1 and/or the system 200a of FIG. 2A. In various embodiments, the system 200b may be at least partially implemented in a cloud-based environment.

The system 200b may be similar to the system 200a of FIG. 2A, with the exception that the function 202 may be additionally, or alternatively, coupled to an LLM 220 and an image generating model 222. The image generating model 222 may utilize diffusion-based image synthesis or other generative techniques to create new data samples. Diffusion models are a type of generative model that progressively refine random noise into coherent images through a series of transformations. These models can be employed for various tasks, including image generation, image-to-image translation, and text-to-image synthesis. By leveraging the diffusion process, the image generating model 222 can produce high-quality images that align with the textual descriptions.

In one or more embodiments, the function 202 may, based on a query 250a’, perform a search of the image knowledge base 212 (FIG. 2A) to identify suitable matches. In a case where the function 202 identifies no matching images, the function 202 may leverage any identified text data (250d, 250e) obtained based on a search of the text knowledge base 218 to generate one or more images 250i’ corresponding to the query 250a’. Particularly, the function 202 may generate a query 250g’ that includes the obtained text data, and may submit that query to the LLM 220 to generate output text. This output text may serve as an explanation or a detailed description of the query, which can be fed into the image generating model 222 to generate image(s) 250i’. The function 202 may prepare a response 250j’ to the query 250a’ that includes the generated image(s) 250i’. In this way, the system 200b may leverage text-based RAG and image generation to address queries that do not result in the retrieval of suitable images from the image storage 204.

It is to be understood and appreciated that, although one or more of FIGS. 2A -2C might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various models, systems, devices, components, networks, modules, etc. may have been illustrated in one or more of FIGS. 2A -2C as separate models, systems, devices, components, networks, modules, etc., it will be appreciated that multiple models, systems, devices, components, networks, modules, etc. can be implemented as a single model, system, device, component, network, module, etc., or a single model, system, device, component, network, module, etc. can be implemented as multiple models, systems, devices, components, networks, modules, etc. Additionally, functions described as being performed by one model, system, device, component, network, module, etc. may be performed by multiple models, systems, devices, components, networks, modules, etc., or functions described as being performed by multiple models, systems, devices, components, networks, modules, etc. may be performed by a single model, system, device, component, network, module, etc.

FIG. 2D depicts an illustrative embodiment of a method 258 in accordance with various aspects described herein.

At 258a, the method can include receiving an input image relating to one or more network elements of a telecommunications network. For example, the system 200a/200b can, similar to that described above with respect to one or more of FIGS. 2A-2C, perform one or more operations that include receiving an input image relating to one or more network elements of a telecommunications network.

At 258b, the method can include deriving an embedding based on the input image, resulting in an input image embedding. For example, the system 200a/200b can, similar to that described above with respect to one or more of FIGS. 2A-2C, perform one or more operations that include deriving an embedding based on the input image, resulting in an input image embedding.

At 258c, the method can include conducting a search for the input image embedding in a vector database that stores embeddings associated with images relating to telecommunications network elements. For example, the system 200a/200b can, similar to that described above with respect to one or more of FIGS. 2A-2C, perform one or more operations that include conducting a search for the input image embedding in a vector database that stores embeddings associated with images relating to telecommunications network elements.

At 258d, the method can include determining whether a particular embedding in the vector database corresponds to the input image embedding. For example, the system 200a/200b can, similar to that described above with respect to one or more of FIGS. 2A-2C, perform one or more operations that include determining whether a particular embedding in the vector database corresponds to the input image embedding.

At 258e, the method can include based on a determination that there is a lack of a particular embedding in the vector database that corresponds to the input image embedding, causing a corrective action to be taken with respect to the one or more network elements of the telecommunications network. For example, the system 200a/200b can, similar to that described above with respect to one or more of FIGS. 2A-2C, perform one or more operations that include based on a determination that there is a lack of a particular embedding in the vector database that corresponds to the input image embedding, causing a corrective action to be taken with respect to the one or more network elements of the telecommunications network.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

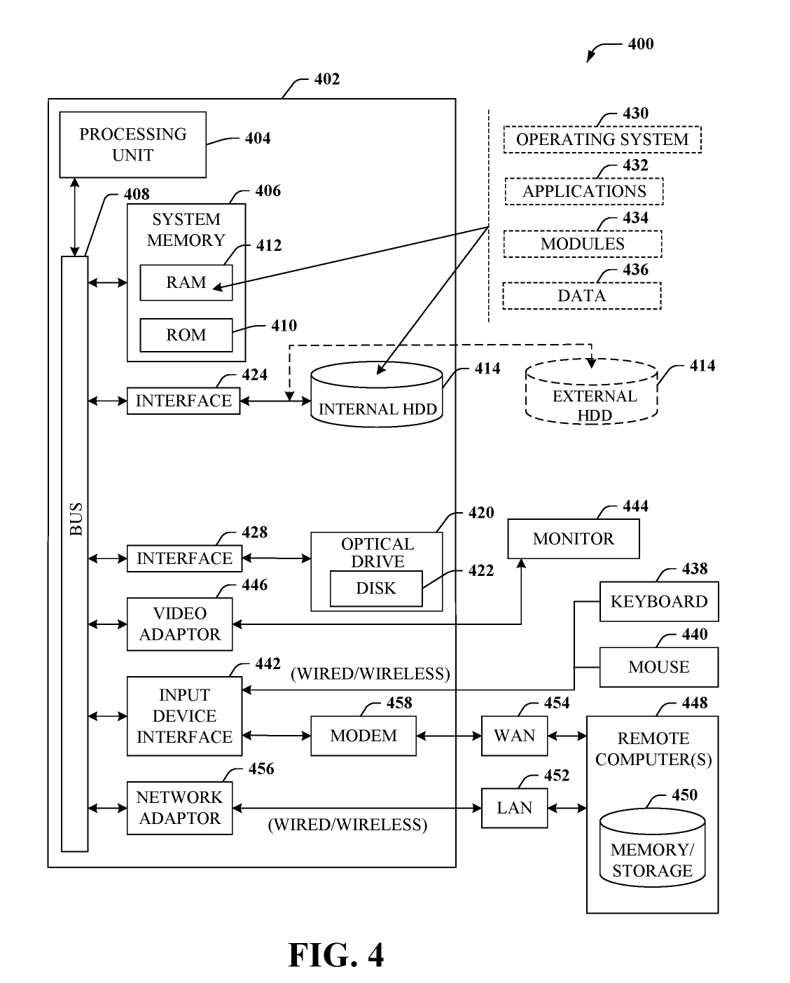

Referring to FIG. 2E, an example AI architecture 260 may be used to facilitate training and/or pre-training of AI models, such as such as those described above with respect to one or more of FIGS. 2A-2C. For instance, the AI architecture 260 may be used to facilitate training and/or pre-training of an LLM, which may be or may include an LLM that is based on the transformer model 270 illustrated in FIG. 2F and described in more detail below. The AI architecture 260 may include an input module 262, a preprocessor 264, and a training module 266. Some or all of these modules, which may be referred to as programs, processors, or agents, may be realized based on execution of instructions or data by one or more processors of a computing (or ML) system, such as the computing system 400 of FIG. 4 (described in more detail below).

The input module 262 may allow for input of (e.g., user-provided) data, such as datasets, parameters (e.g., weights, biases, and/or the like), etc., that can be used to train models and/or obtain predictions from models. In some cases, datasets may be labeled and may include inputs (e.g., observed or measured values) and known output data. Labeled datasets may facilitate supervised (or guided) learning.

Although not shown, the AI architecture 260 may include a library of ML models or algorithms, such as, for instance, one or more classifiers (e.g., a naïve Bayes classifier or the like), one or more support vector machines, one or more artificial neural networks (e.g., transformer neural networks, convolutional neural networks, and/or the like), one or more learned decision trees, and so on. Each of the ML algorithms may be associated with various parameters.

The preprocessor 264 may be equipped with one or more preprocessing algorithms that are configured to prepare input datasets for processing by the training module 266. Such preprocessing may include discretization (where values are binned or converted into nominal values), component analysis, data estimation, feature selection, feature extraction (e.g., dimensionality reduction, data removal, statistical analysis, threshold-based filtering, etc.), data interpolation, and/or the like.

The training module 266 may be configured to train and evaluate ML models. As an example, the training module 266 may be configured to perform unsupervised learning and/or supervised learning based in input datasets. In exemplary embodiments, the training module 266 may be capable of training and/or evaluating the performance of multiple models in parallel. In one or more implementations, the training module 266 may, despite operating on multiple ML models in parallel, train and evaluate the various ML models individually. In some implementations, the training module 266 may be capable of combining the procedure outcomes of multiple models to derive an aggregate outcome. Model evaluation or validation may involve a comparison of model outputs to known outputs or an analysis of model outputs relative to desired metrics.

In exemplary embodiments, certain processing techniques may be employed to generate usable data sets for feeding into the AI architecture 260 to train deep learning neural network model(s) to output predictions. Although not shown, the AI architecture 260 may include additional functional modules, such as those for gathering performance results and presenting (e.g., displaying) data regarding the results. While various components, modules, etc. may have been illustrated in FIG. 2E as separate components, modules, etc., it will be appreciated that multiple components, modules, etc. may be implemented as a single component, module, etc., or a single component, module, etc. may be implemented as multiple components, modules, etc. Additionally, functions described as being performed by one component, module, etc. may be performed by multiple components, modules, etc., or functions described as being performed by multiple components, modules, etc. may be performed by a single component, module, etc.

Referring to FIG. 2F, an example transformer model 270 (a portion or an entirety of which may serve as a functional building block of one or more LLMs, such as any of the generative AI model(s) described above with respect to one or more of FIGS. 2A-2C) may include an encoder 272 and a decoder 274. The encoder 272 may include an input embedding block 272b, a positional encoder 272c, and a series of (i.e., multiple (Nx)) identical layers that each has a multi-head attention block 272m and a feed forward block 272f. An input (e.g., text, such as a query or a prompt) may be converted into individual tokens (e.g., words, characters, etc.) that are fed into the input embedding block 272b. The input embedding block 272b may convert the tokens into continuous vectors, where each token is mapped to a high-dimensional space by way of a learned embedding matrix. The embedding matrix may be implemented in a lookup table or the like, where token indexes are associated with different vectors of a fixed size. The positional encoder 272c may derive fixed positional encodings or learned positional encodings to help capture positional information of tokens. Fixed positioning encodings may be generated using sinusoidal functions, where the different frequencies of sine/cosine functions correspond to unique positional encodings for the different positions in a given sequence. Learned positional encodings may be learned during training based on initially randomly chosen values that are optimized as part of the training process. In any case, the positional encodings may be combined with the input embeddings from the input embedding block 272b on an element-by-element basis, resulting in a processed input that may be fed into the series of layers. The processed input may be fed into the multi-head attention block 272m in the first layer. An addition (or residual connection) and normalization block 272x may operate on the processed input and the output of that multi-head attention block 272m. The output of the addition and normalization block 272x may be passed to the feed forward block 272f in that layer. An addition and normalization block 272y may operate on the output of the addition and normalization block 272x and the output of the feed forward block 272f. In essence, the multi-head attention block 272m of a given layer may enable the feed forward block 272f in that layer to model long term dependencies. Multi-head attention allows the model to simultaneously attend to different parts of the input sequence and weigh their importance based on the input sequence’s internal relationships. This attention mechanism may be combined with the input sequence’s representations to produce a new set of weighted representations. Iterating the identical layers allows the model to learn complex patterns and relationships in the data.

The decoder 274 may include an output embedding block 274b, a positional encoder 274c, and a series of (i.e., multiple (Mx)) identical layers that each has a masked multi-head attention block 274k, a multi head attention block 274m, and a feed forward block 274f. An output (shifted right) may be converted into individual tokens that are fed into the output embedding block 274b. The output embedding block 274b may convert the tokens into continuous vectors. The positional encoder 274c may derive fixed positional encodings or learned positional encodings to help capture positional information of tokens. The processed output may be fed into the masked multi-head attention block 274k in the first layer. An addition and normalization block 274w may operate on the processed output and the output of that masked multi-head attention block 274k. The output of the addition and normalization block 274w may be passed to the multi-head attention block 274m in that layer. Output(s) from the encoder 272 may also be fed into the multi-head attention block 274m. An addition and normalization block 274x may operate on the output of the addition and normalization block 274w and the output of multi-head attention block 274m. The output of the addition and normalization block 274x may be passed to the a feed forward block 274f in that layer. An addition and normalization block 274y may operate on the output of the addition and normalization block 274x and the output of the feed forward block 274f. The output of the addition and normalization block 274y may may be passed to a linear layer 274r, which may transform that output into a higher-dimensional space. The output of the linear layer 274r may be fed into a softmax layer 274s, which may be a non-linear activation function that normalizes the output to a probability distribution to ensure that all values are non-negative and add up to 1. Iterating the identical layers allows the model to learn complex patterns and relationships in the data.

Various types of transformer-based LLMs may be constructed by “stacking” the identical layers of the encoder 272 and/or the decoder 274 in particular arrangements and in combination with additional refinements/components. A given LLM constructed as such may then be trained or pre trained (e.g., using the AI architecture 260 of FIG. 2E, a similar AI architecture, a different AI architecture or a combination of some or all of these AI architectures) on a corpus of information and/or finetuned or instruction tuned to analyze/generate data (e.g., text, audio, and/or images).

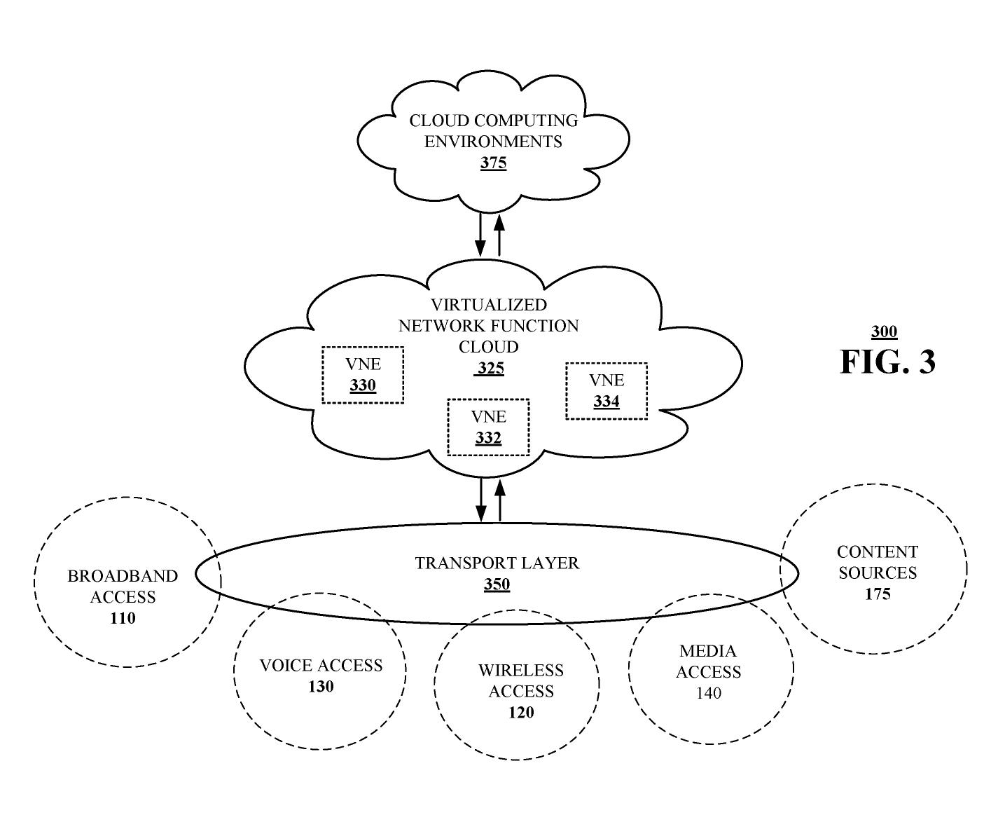

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of systems 200a, 200b, and 255, and method 258 presented in FIGS. 1 and 2A-2D . For example, virtualized communications network 300 can facilitate, in whole or in part, RAG and image search/understanding for network and equipment assessment and improvement.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements – which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers – each of which adds a portion of the capability, and which creates an overall elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, RAG and image search/understanding for network and equipment assessment and improvement.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), and an optical disk drive 420, (e.g., reading a CD-ROM disk 422 or, to read from or write to other high capacity optical media such as the DVD). The HDD 414, and optical disk drive 420 can be connected to the system bus 408 by a hard disk drive interface 424 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

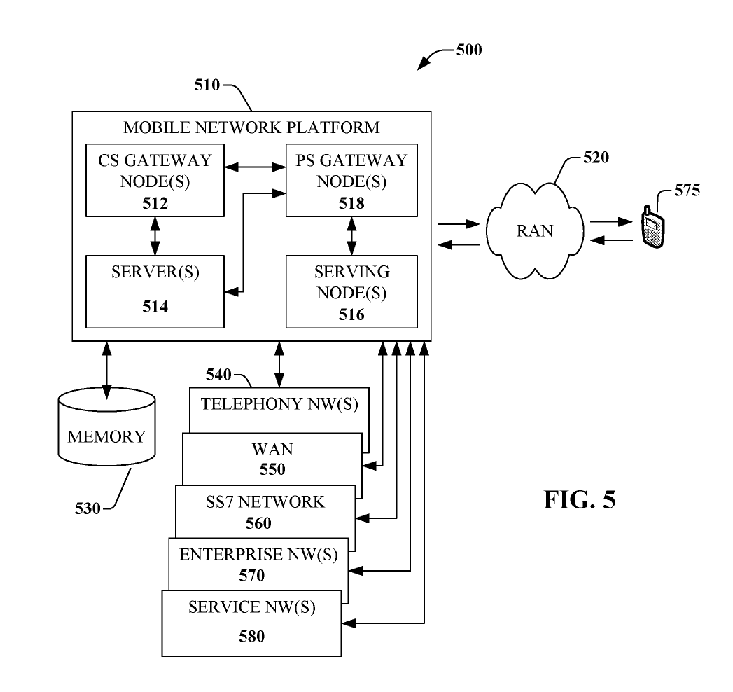

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, RAG and image search/understanding for network and equipment assessment and improvement. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format …) such flows. Such application(s) can comprise add-on features to standard services (for example, provisioning, billing, customer support …) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network’s operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

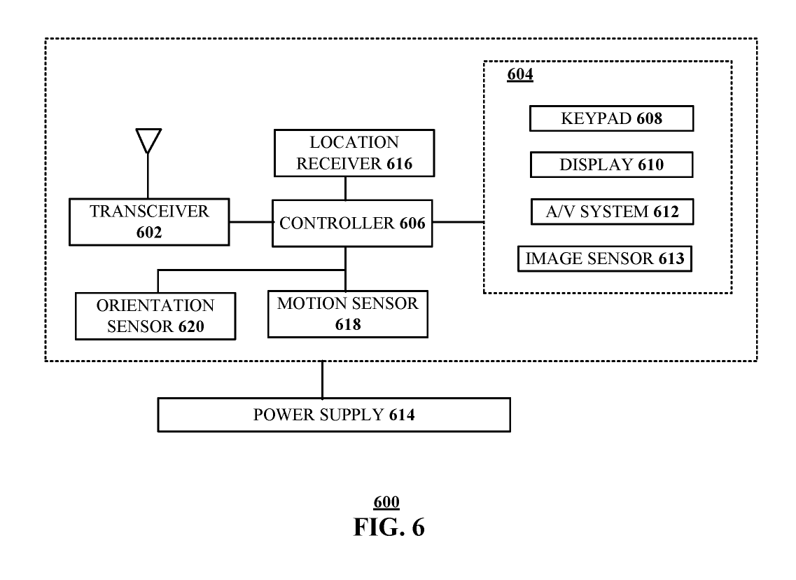

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via communications network 125. For example, computing device 600 can facilitate, in whole or in part, RAG and image search/understanding for network and equipment assessment and improvement.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth^{®}, ZigBee^{®}, Wi-Fi, DECT, or cellular communication technologies, just to mention a few (Bluetooth^{®} and ZigBee^{®} are trademarks registered by the Bluetooth^{®} Special Interest Group and the ZigBee^{®} Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth^{®}. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user’s finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth^{®}, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for conducting various embodiments thereof. Moreover, the classifier can be employed to determine a ranking or priority of each cell site of the acquired network. A classifier is a function that maps an input attribute vector, x = (x1, x2, x3, x4, …, xn), to a confidence that the input belongs to a class, that is, f(x) = confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. A system, comprising:
at least one processor; and
at least one memory that stores executable instructions that, when executed by the at least one processor, facilitate performance of operations, the operations comprising:
receiving an input image relating to one or more network elements of a telecommunications network;
deriving an embedding based on the input image, resulting in an input image embedding;
conducting a search for the input image embedding in a vector database that stores embeddings associated with images relating to telecommunications network elements;
determining whether a particular embedding in the vector database corresponds to the input image embedding; and
based on a determination that there is a lack of a particular embedding in the vector database that corresponds to the input image embedding, causing a corrective action to be taken with respect to the one or more network elements of the telecommunications network.

2. The system of claim 1, wherein the corrective action comprises causing an alert to be generated regarding non-compliance of the one or more network elements of the telecommunications network.

3. The system of claim 1, wherein the corrective action comprises causing a replacement order to be placed for the one or more network elements of the telecommunications network.

4. The system of claim 1, wherein the corrective action comprises adjusting one or more settings of an environmental control device associated with the one or more network elements of the telecommunications network.

5. The system of claim 1, wherein the corrective action comprises causing a software update relating to the one or more network elements of the telecommunications network to be downloaded and installed.

6. The system of claim 1, wherein the vector database is associated with one or more AI models that are trained to generate text-based descriptions from inputted images.

7. The system of claim 1, wherein the operations further comprise, based on a determination that the particular embedding that corresponds to the input image embedding is found, causing a message indicative of compliance of the one or more network elements of the telecommunications network to be output.

8. The system of claim 1, wherein operations further comprise:
causing one or more artificial intelligence (AI) models to generate text-based descriptions of a plurality of images of telecommunications network elements;
generating a plurality of embeddings from the text-based descriptions;
storing, in a vector database, the plurality of embeddings and corresponding storage location information for the plurality images;
receiving a text-based query;
identifying embedding information for at least one image of the plurality of images that corresponds to the text-based query;
obtaining the at least one image from a corresponding storage location of the at least one image; and
causing the at least one image to be output as part of a response to the text-based query.

9. The system of claim 8, wherein the operations further comprise:
retrieving second embedding information for particular text data that corresponds to the text-based query;
obtaining the particular text data from a corresponding storage location of the particular text data; and
causing the particular text data to be output as part of the response to the text-based query.

10. The system of claim 8, wherein the text-based query is derived from an image of a document.

11. The system of claim 1, wherein the operations further comprise:
causing one or more artificial intelligence (AI) models to generate text-based descriptions of a plurality of images of telecommunications network elements;
generating a plurality of embeddings from the text-based descriptions;
storing, in a vector database, the plurality of embeddings and corresponding storage location information for the plurality images;
receiving a text-based query;
conducting a first search for particular text data that corresponds to the text-based query; and
obtaining the particular text data based on the first search.

12. The system of claim 11, wherein the operations further comprise:
conducting a second search for at least one embedding of the plurality of embeddings that corresponds to the text-based query;
determining, based on the second search, that none of the plurality of embeddings corresponds to the text-based query;
based on the determining that none of the plurality of embeddings corresponds to the text-based query, causing the text-based query and the particular text data to be inputted into an image generating AI model to derive a generated image; and
causing the generated image to be output as part of a response to the text-based query.

13. A non-transitory machine-readable medium, comprising executable instructions that, when executed by a processing system including a processor, facilitate performance of operations, the operations comprising:
receiving an input image relating to one or more network elements of a radio access network (RAN);
deriving an embedding based on the input image, resulting in an input image embedding;
conducting a search for the input image embedding in a vector database that stores embeddings associated with images relating to RAN elements;
determining whether a particular embedding in the vector database corresponds to the input image embedding; and
based on a determination that there is a lack of a particular embedding in the vector database that corresponds to the input image embedding, causing a corrective action to be taken with respect to the one or more network elements of the RAN.

14. The non-transitory machine-readable medium of claim 13, wherein the operations further comprise causing a replacement order to be placed for the one or more network elements of the RAN.

15. The non-transitory machine-readable medium of claim 13, wherein the corrective action comprises adjusting one or more settings of an environmental control device associated with the one or more network elements of the RAN.

16. The non-transitory machine-readable medium of claim 13, wherein the corrective action comprises causing a software update relating to the one or more network elements of the RAN to be downloaded and installed.

17. The non-transitory machine-readable medium of claim 13, wherein the corrective action comprises causing an alert to be generated regarding non-compliance of the one or more network elements of the RAN.

18. A method, comprising:
receiving, by a processing system including a processor, an input image relating to one or more elements of a core network;
deriving, by the processing system, an embedding based on the input image, resulting in an input image embedding;
conducting, by the processing system, a search for the input image embedding in a vector database that stores embeddings associated with images relating to core network elements;
determining, by the processing system, whether a particular embedding in the vector database corresponds to the input image embedding; and
based on a determination that there is a lack of a particular embedding in the vector database that corresponds to the input image embedding, causing, by the processing system, a corrective action to be taken with respect to the one or more elements of the core network.

19. The method of claim 18, wherein the corrective action comprises adjusting one or more settings of an environmental control device associated with the one or more elements of the core network.

20. The method of claim 18, wherein the corrective action comprises causing a software update relating to the one or more elements of the core network to be downloaded and installed.
